(19) United States
(12) Patent Application Publication
(10) Pub. No.: US 2010/0106262 A1
(43) Pub. Date: Apr. 29, 2010

(54) DEVICE FOR A NETWORKED CONTROL SYSTEM

(75) Inventors: Oliver Schreyer, Herzogenrath (DE); Bozena Erdmann, Aachen (DE); Armand Michel Marie Lelkens, Heerlen (NL); Robert Van Herk, Dordrecht (NL); Mark Henricus Verberkt, Eindhoven (NL); Engel Johannes Knibbe, Heeze (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS N.V., EINDHOVEN (NL)

(21) Appl. No.: 12/525,853

(22) PCT Filed: Feb. 7, 2008
(86) PCT No.: PCT/IB08/50445

§ 371 Date: Aug. 5, 2009

(30) Foreign Application Priority Data
Feb. 12, 2007 (EP) 07102125.7

(51) Int. Cl. G05B 19/04; G05B 13/02

(52) U.S. Cl. 700/28; 700/87; 700/86

(57) ABSTRACT

The invention relates to a networked control system, comprising a plurality of devices (100a, 100b, 100c), wherein each device (100a, 100b, 100c) is specified by a corresponding device logic and means (332) for collecting the device logics of the plurality of devices (100a, 100b, 100c) and for specifying a runtime behaviour of at least one device (100b) of the plurality of devices (100a, 100b, 100c) based on a device logic corresponding to the at least one device (100b). The networked control system further comprises means (334) for generating at least one device independent control logic program which defines the runtime behaviour of the at least one device (100b) and an apparatus for translating the at least one device independent control logic program into a device specific control logic code which is assigned to a selected device (100c).

The invention relates in general to networked control systems such as a complex lighting system and in particular to the communication in such networked control systems.

Networked control systems are a ubiquitous trend in commercial, industrial and institutional business markets and also in consumer markets. Examples for networked control systems are building automation systems, e.g. for lighting, heating and ventilation or safety. A networked control system may consist of devices like light ballasts, switches, daylight or occupancy sensors, actuators or meters. The devices are preferably connected wirelessly i.e. via RF (radio frequency) modules. The functionality of a networked control system is typically defined by device logic consisting of states and functions of the devices and by control applications that interact with the device logic. The states and functions of the devices may be vendor-defined and are often standardized. The control applications may be vendor-defined and are sometimes user-defined. The control applications usually interact with multiple devices by issuing commands to different devices or by taking information of or from multiple devices as input. In general, considering a device and a piece of control application software assigned to it, some of the interactions between control and device logic are local to the device, while others have to rely on the communication of information between devices via communication protocols or other mechanisms known in the art.

US2003/0040813A1 relates to a method and apparatus for providing distributed control of a home automation system and describes an operation principle for distributed control applications. In US2003/0040813A1 logic pieces are defined for respective devices and assigned an identifier (scene identifier) that may be used to simultaneously activate the logic pieces by sending the identifier to all related devices. Since only identifiers are communicated between the devices, the possible functionality is limited.

It is an object of the present invention to provide an improved device for a networked control system which particularly allows to improve the communication in the networked control system.

The object is solved by the independent claim(s). Further embodiments are shown by the dependent claim(s).

A basic idea of the invention is to perform communication of control-related information in a networked control system transparently to a control application. This allows a user or a logic designer of the networked control system to define control logic on the collection of particular or of all devices in a target system, without specifying the device or devices the related runtime code shall be executed on and, thus, without the need for a user to specify any communication aspects. The control logic and also its design process becomes significantly simpler, more compact and allows for more flexibility, e.g. when adding new functionality. Furthermore, as the invention allows to assign control logic to any device of the target system, computer-controlled and automated optimisation of the target control system, e.g. with respect to device capabilities or resources may be enabled.

According to embodiments of the invention, development and establishment of control applications independent of distribution aspects are enabled. This allows reducing the complexity of the control logic, as a user sees it, and of the logic design process. Further a free allocation of control logic to devices may be enabled which allows for computer-controlled and automated system optimisation after application development. Due to the invention, also non-technical skilled users may define and setup the control logic easily and in an optimal way. Furthermore, adding new control functionality to a running system becomes easier.

In the following, some important terms used herein are explained.

The term “networked control system” means a system comprising a plurality of connected nodes or devices. The devices may be connected by a communication system, for example a wireless communication system. The networked control system may be a complex lighting control system with occupancy and daylight sensors and pre-defined rules, e.g. for weekdays and weekends, working and after work hours, a building automation system, a home control system, an atmosphere lighting system or any other control and automation environment, including industrial, retail, institutional and residential.

The term “device” means any node of the “networked control system”. The device logic may comprise information about capabilities and resources of the corresponding device. Depending on the type of system, the devices may comprise light ballasts, switches, daylight or occupancy sensors, actuators or meters. The devices may be connected via radio frequency modules. Each device may be specified by corresponding device logic.

The term “device logic” means possible control parameters and functions, provided by the device. The device logic may represent attributes of hardware or software states of the corresponding device and define a device state and local device functions. The device logic may be represented by device “state variables” representing the attributes of the hardware and software state of the device.

The term “runtime behaviour” of a device means the functionality of the device during normal operation of the networked control system.

The term “control logic program” means a device independent program which describes the runtime behaviour of one or a plurality of devices. A control logic program may include user-defined “system” state variables (in addition to the device state variables). The control logic program may basically consist of operations on the state variables formulated in a programming language.

The term “control logic code” means a device specific software program being a translation of a corresponding control logic program. The control logic code is assigned to a selected device. The control logic code may be optimized for being executed on the selected device and may not run on other devices. The control logic code may be an interpretable byte code.

According to an embodiment of the invention, a device for a networked control system including a plurality of devices is provided, comprising:
a receiver for receiving a control logic code which allows controlling a runtime behaviour of at least one device of the plurality of devices;
a runtime environment for executing the control logic code; and
a support logic being adaptable to the control logic code, wherein the support logic provides a communication link for exchanging state variables necessary for executing the control logic code.

The control logic code controlling the runtime behaviour of at least one device of the plurality of devices of the networked control system may be assigned to and executed on any selected device of the networked control system.

According to an embodiment of the invention, the at least one device may include the selected device, the control logic code is executed on. This means, that the selected device may control its own runtime behaviour by executing the control logic code.

According to an alternative embodiment, the at least one device may not include the selected device.

According to an embodiment of the invention, the at least one device may include at least one further device besides the device, the control logic is executed on and the support logic may comprise storage for storing state variables from a device being not the selected device. The storage has the advantage that during control logic execution state variables required by the control logic code do not have to be transmitted from an external device but can be read from the internal storage.

According to an embodiment of the invention, the communication link may allow reading actual state variables defining an actual state of the at least one device and may allow transmitting changed state variables to the at least one device in order to execute the control logic code. According to a further embodiment of the invention, the communication link may be transparent to the control logic code.

According to a further embodiment of the invention, the support logic may comprise means for receiving an instantiation message and may be configured to adapt itself to the control logic code based on the instantiation message.

According to a further embodiment of the invention, the receiver may be configured to receive a further control logic code which allows controlling a runtime behaviour of at least one second device of the plurality of devices, wherein the runtime environment may be configured to execute the further control logic code and wherein the support logic may be adaptable to the further control logic code.

According to an embodiment of the invention, the receiver may be configured to receive the control logic code via the communication link.

According to a further embodiment of the invention, the runtime environment may be a virtual machine.

According to an embodiment of the invention, an apparatus for initializing a networked control system with a plurality of devices according to the invention is provided, comprising:
means for translating a device independent control logic program which defines a runtime behaviour of at least one device of the plurality of devices into a control logic code being executable on a selected device of the plurality devices;
means for transmitting the control logic code to the selected device; and
means for adapting a support logic of the selected device and the support logic of all devices having state variables used in the control logic program, wherein the support logic provides a communication link for exchanging state variables necessary for controlling the runtime behaviour of the at least one device.

All the devices having state variables used in the control logic program may provide input state variables for the control logic program. For a control logic code assigned to one selected device, not only the support logic of the selected device but also the support logic of all (master) devices of input with state variables used in the control program has to be adapted. In particular subscription table entries are adapted.

According to an embodiment of the invention, each device of the plurality of devices may be specified by a corresponding device logic and the means for translating may be configured to take into account a device logic corresponding to the selected device such that the translated control logic code is adapted to the selected device. This allows adapting the control logic code to the selected device.

According to a further embodiment of the invention, the means for translating may be configured to select the selected device, based on the device logic corresponding to the selected device. This allows selecting a device of the plurality of devices of the networked control system which is most suitable for executing the control logic code.

The device logic may comprise information about capabilities and resources of the selected device, according to an embodiment of the invention.

According to a further embodiment of the invention, the means for translating may be configured to translate a further device independent control logic program which defines a runtime behaviour of at least one further device of the plurality of devices into a further control logic program code being executable on a further selected device of the plurality devices,

the means for transmitting may be configured to transmit the further control logic code to a runtime environment of the further selected device for executing the further control logic code, and

the means for adapting may be configured to adapt a support logic of the further selected device.

According to a further embodiment of the invention, the means for translating may be configured to receive the device independent control logic program and the further device independent control logic program from a pool of control logic programs defining a runtime behaviour of the plurality of devices of the networked control system.

According to an embodiment of the invention, the apparatus may be configured to translate and transmit the further control logic code for updating the networked control system during operation.

According to a yet further embodiment of the invention, the further selected device may be the selected device and the further device independent control logic program may be a replacement for the control logic program being executed on the selected device.

According to a yet further embodiment of the invention, a networked control system is provided, comprising:
a plurality of devices according to the invention, wherein each device is specified by a corresponding device logic;
means for collecting the device logics of the plurality of devices and for specifying a runtime behaviour of at least one device of the plurality of devices based on a device logic corresponding to the at least one device;
means for generating at least one device independent control logic program which defines the runtime behaviour of the at least one device; and
an apparatus for initializing according to the invention.

According to an embodiment of the invention, the device logics represent attributes of hardware or software states of the corresponding devices.

According to a further embodiment of the invention, the means for collecting may comprise an interface which allows a user to specify the runtime behaviour of the at least one device.

According to an embodiment of the invention, the interface may allow the user to define the selected device. The interface may be a graphic interface, according to an embodiment of the invention.

According to a further embodiment of the invention, the means for collecting may be configured to specify the runtime behaviour of the at least one device based on further device logics corresponding to further devices the runtime behaviour of the at least one devices depends on.

According to a yet further embodiment of the invention, the means for collecting may be configured to specify a runtime behaviour of all the plurality of devices based on all device logics and the means for generating may be configured to provide a plurality of device independent control logic programs to define the runtime behaviour of all the plurality of devices.

According to an embodiment of the invention, the networked control system may further comprise at least one application being adapted to controlling a group of devices by means of operations on common state variables of the group of devices or on a set of values of the group of devices. Groups are an essential concept for logic design and maintenance and allow operations on common state variables of a set of devices, for example “set dim level of all lamps to value X”, or operations on a set of values, for example “average daylight value measured by a group of sensors”. Groups can be derived from abstract design, for example “all lamps in the living room”, which leads to a typed group, for example group of type lamp. A group may be as well be manually defined in direct design by arbitrarily grouping physical devices, for example all devices in a room (“arbitrary group” having no type).

According to a further embodiment of the invention, a method for initializing a networked control system with a plurality of devices according to the invention is provided, comprising:
translating a device independent control logic program which defines a runtime behaviour of at least one device of the plurality of devices into a control logic code being executable on a selected device of the plurality devices;
transmitting the control logic code to the selected device; and
adapting a support logic of the selected device and the support logic of all devices having state variables used as input in the control logic program, wherein the support logic provides a communication link for exchanging state variables necessary for executing the control logic code.

According to an embodiment there may also be state variables used in the control logic program as output, i.e. state variables that are changed by the control logic program. The support logic of the (external) master devices of these devices does not need to be changed, as those devices will just receive a change notification for those (output) state variables which is inherent support logic at all devices, in comparison to e.g. subscriptions.

According to a further embodiment of the invention, a method for establishing a networked control system is provided, comprising:
providing a plurality of devices according to the invention, wherein each device is specified by a device logic;
collecting the device logics of the plurality of devices and specifying a runtime behaviour of at least one device of the plurality of devices based on a device logic corresponding to the at least one device;
generating at least one device independent control logic program defining the runtime behaviour of the at least one device; and
initializing the networked control system according to the invention.

According to an embodiment, the method for establishing a networked control system, further comprises a step of generating at least one new device independent control logic program defining the runtime behaviour of the at least one device, a step of translating the at least one new device independent control logic program into a new control logic code being executable on a selected device of the plurality devices, a step of transmitting the new control logic code to the selected device and a step of adapting a support logic of the selected device and the support logic of all devices having state variables used as input in the at least one new device independent control logic program, which in this case is an incremental operation.

Incremental operation may mean to add information to the existing support logic.

Further, the networked control system may be in operation, while the steps concerning the at least one new device independent control logic program are performed.

According to a further embodiment of the invention, a method for adding new functionality to a networked control system according to an embodiment of the invention is provided, comprising:
generating at least one new device independent control logic program defining the runtime behaviour of the at least one device;
translating the at least one new device independent control logic program into a new control logic code being executable on a selected device of the plurality devices;
transmitting the new control logic code to the selected device; and
adapting a support logic of the selected device and the support logic of all devices having state variables used as input in the at least one new device independent control logic program, which in this case is an incremental operation.

The incremental operation may mean to add information to existing support logic.

The networked control system may be in operation while the method for adding new functionality is performed.

According to an embodiment of the invention, a computer program may be provided, which is enabled to carry out the above method according to the invention when executed by a computer.

According to a further embodiment of the invention, a record carrier storing a computer program according to the invention may be provided, for example a CD-ROM, a DVD, a memory card, a diskette, or a similar data carrier suitable to store the computer program for electronic access.

These and other aspects of the invention will be apparent from and elucidated with reference to the embodiment(s) described hereinafter.

The invention will be described in more detail hereinafter with reference to exemplary embodiments. However, the invention is not limited to these exemplary embodiments.

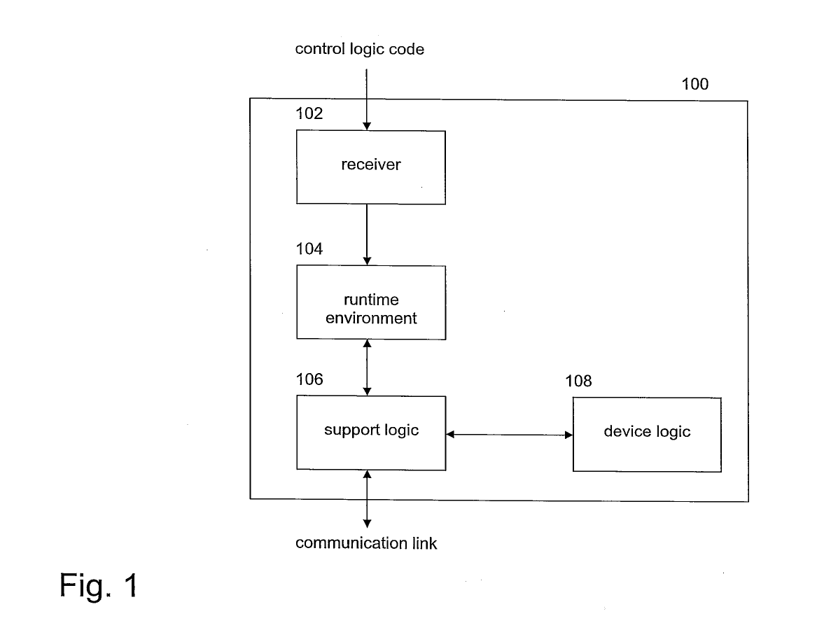

FIG. 1 shows a device according to the invention;

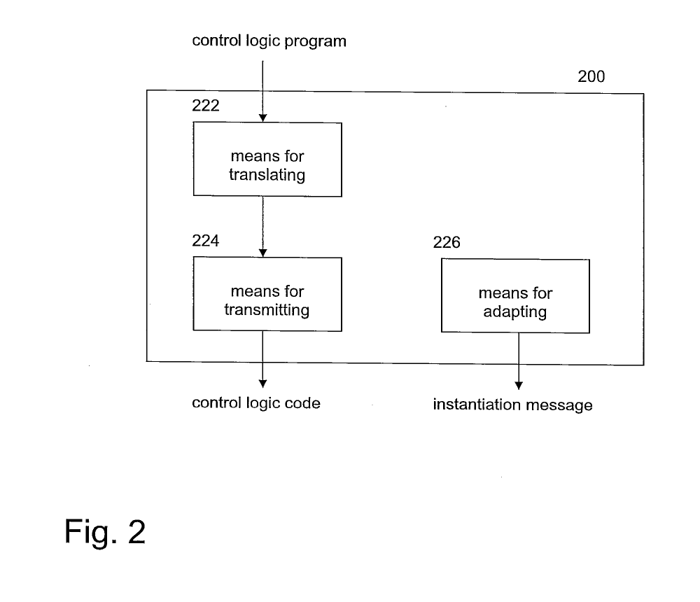

FIG. 2 shows an apparatus for initializing a networked control system according to the invention; and

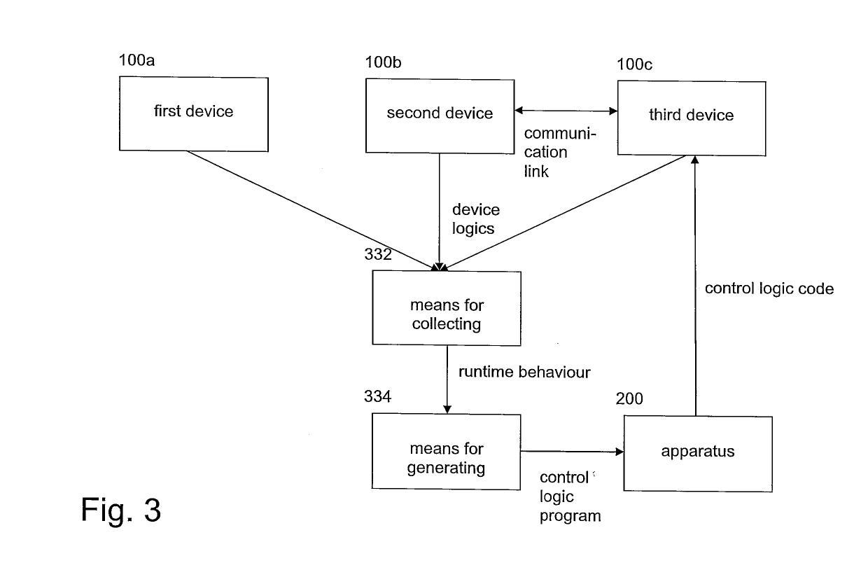

FIG. 3 shows a networked control system according to the invention.

In the following, functional similar or identical elements may have the same reference numerals.

FIG. 1 shows a device 100 according to an embodiment of the present invention. The device is suitable for use in a networked control system consisting of a plurality of devices. The device 100 comprises a receiver 102, a runtime environment 104, a support logic 106 and a device logic 108.

The device 100 is configured to receive a control logic code via the receiver 102. The received control logic code is assigned to the particular device 100. The receiver 102 is configured to provide the control logic code to a runtime environment 104. The runtime environment 104 is configured to execute the control logic code (executor). An execution of the control logic code allows controlling a runtime behaviour of at least one device of the plurality of devices of the networked control system. The at least one device may be the device 100 which executes the control logic code or may be any other device of the networked control system. The control logic code may control the runtime behaviour of a plurality of devices of the networked control system. In this case, the device 100 which executes the control logic code may be part of the devices controlled by the control logic code or not. In other words, the control logic code may control the runtime behaviour of any device of the networked control system, including the device 100 it is executed on.

For controlling the runtime behaviour, the control logic code needs to receive actual state variables of the devices to be controlled and needs to transmit changed state variables to the devices to be controlled. The state variables may be necessary for executing the control logic code. A transmission of the state variables between the control logic code executed in the runtime environment 104 and the devices to be controlled is performed by the support logic 106. The support logic 106 is adaptable to the control logic code and is configured to provide a communication link for exchanging the state variables.

According to an embodiment the support logic 106 may comprise means for receiving an instantiation message. The instantiation message may be received from external together with the control logic code or may be generated internal after having received the control logic code. The instantiation message may adapt the support logic 106 to the requirements of the control logic code and in particular establish the communication link such that state variable can be received from and transmitted to the devices which are to be controlled by the control logic code.

The device 100 may be configured to host more than one control logic code. Thus, the receiver 102 may be configured to receive further control logic codes which allow controlling runtime behaviours of further devices. The runtime environment 104 may be configured to execute the further control logic codes and the support logic 106 may be adaptable to support the further control logic codes.

The networked control system consists of nodes or devices connected by a communication sub-system (shown in the FIG. 3). A node or device 100 of the networked control system is, out-of-the-box described by its device logic 108. The device logic 108 defines a device state and local device functions. The device logic 108, i.e. possible control parameters and functions, provided out-of-the-box by the device 100, may be exclusively represented by device state variables representing the attributes of the hardware and software state of the device 100, for example the dimming level of a lamp. Thus, a state variable belongs to one and only one device 100 in the target system. In other words, a particular state variable belongs to the particular device 100 it represents the state of. This device 100 is called master device of the state variable. Changes of the attribute value in the master device hardware or software will be reflected by changes in the state variable value and vice versa.

The device 100 is equipped with the runtime environment 104 for executing the control logic code. A control application in the networked control system in general operates on the device logic of one or typically multiple devices. The runtime environment 104 may be a virtual machine interpreting byte code including the access mechanisms to the internal device logic 108 and internal state variables.

The device 100 further comprises the support logic 106, responsible for transport of control-related information. This allows a control application design based solely on device logic and transparent communication of control-related information. The realisation of the support logic 106 depends on the implementation of the runtime networked control system. The support logic ensures that the support logic code runs with correct state variable values even if the state variable values are external. A state variable is external if it belongs to a device different to the device 100 the control logic code is executed on. The support logic 106 of the device 100 is configured to deal with external input state variables and external output state variables. External input state variables are state variables received by the device 100 via the communication link and provided to the runtime environment 104. External output state variables are state variables produced by the executed control logic code which are to be transmitted to the external devices whose runtime behaviour is controlled by the executed control logic code.

According to an embodiment, a device 100 hosting control logic codes stores local copies of all or of particular external input state variables that are needed for the hosted control logic codes. The local copies may be stored in a storage means (not shown in the Figures), like a memory of the device 100. During execution, the control logic codes may use stored local state variable values instead of external state variables. To ensure that a value of the stored copy of the external state variable is up-to-date, the support logic 106 may realise a subscription mechanism. The subscription mechanism may be added to the system by using a subscription table in each master device. A master device is the device a state variable belongs to. The master device stores the subscription table with entries per internal state variable. Each entry lists all devices of the networked control system on which control logic codes are located having this state variable as an input state variable. If the value of an internal state variable changes at the master device, e.g. because the hardware state has changed, the subscription table is checked and change notifications are sent to all devices listed in the entry of this state variable. On receipt of a change notification a control logic code may be triggered if a related definition has been specified for the control logic code, meaning that the state variable is a “trigger state variable”.

External output state variables are handled such that the device 100 hosting control logic codes stores master device addresses for all external output state variables of all hosted control logic codes. When a control logic code changes the value of an external state variable, a change notification is sent to the master device.

According to this embodiment, the entire communication between devices of the networked control system in operational phase consists of the exchange of state variable change notifications, which makes the related support logic very compact and allows for very efficient, application control logic independent implementations.

In the case that new control functionality shall be added to a networked control system already in operation, the subscription tables are not newly defined, but the entries needed for the new functionality are added, in case they are not yet there because of already existing control functionality.

Before initialization of the networked control system, the runtime behaviour of the plurality of devices of the networked control system may be defined by device independent control logic programs. During initialization of the networked control system the device independent control logic programs are translated to device specific control logic codes and assigned to the selected devices. A translation of the logic programs and an assignment of to control logic codes to the selected devices may be performed by an apparatus for initializing.

FIG. 2 shows an apparatus 200 for initializing a networked control system with a plurality of devices, according to an embodiment of the invention. The apparatus 200 is configured to receive a device independent control logic program as an input and is configured to output a control logic code which may be assigned to and executed by the selected device. The selected device may be the device 100 described in FIG. 1. The apparatus 200 may further output an instantiation message which may adapt the support logic of the selected device.

The apparatus 200 comprises means 222 for translating the device independent control logic program which defines the runtime behaviour of at least one device of the plurality of devices of the networked control system. The means 222 for translating is configured to receive the device independent control logic program and to translate the control logic program into a device specific control logic program code being executable on the specified or selected device. The means 222 for translating is configured to provide the control logic program to means 224 for transmitting. The means 224 for transmitting is configured to transmit the control logic code to the selected device. The apparatus 200 further comprises means 226 for adapting the support logic of the selected device. The means 226 for adapting may be configured to provide an instantiation message to the selected device to instantiate the support logic of the selected device.

The means 222 for translating may take into account the device logic of the selected device in order to optimize the control logic code in view of the selected device the control logic code is assigned to. Therefore, the apparatus 200 may be configured to receive the device logic of the selected device. Further, the means 222 for translating may be configured to select the selected device, based on the device logic corresponding to the selected device. Therefore, the means 222 for translating may comprise an additional means for selection which defines the selected device for executing the control logic code on. Selecting the selected device is preferably performed before or during the translation of the control logic program in order to allow adapting the control logic code to the selected device.

The runtime behaviour of the plurality of devices of the networked control system may be controlled by a plurality of control logic programs. Thus, the apparatus 200 may be configured to receive and translate the plurality of control logic programs and to output a plurality of control logic codes. The plurality of control logic codes may be assigned to different of the plurality of devices of the networked control system. Alternatively, the plurality of control logic codes or a number of control logic codes may be assigned to the same device. The means 222 for translating may take the different control logic programs into account when selecting a selected device for a particular logic program code. The means 226 for adapting is configured to adapt the support logics of the different devices to which control logic codes are assigned to.

According to an embodiment, the apparatus 200 may be configured to receive and translate a further control logic program or to output a further control logic code after an initialization of the networked control system. Thus the further control logic code may update the networked control system during operation. The further control logic code may replace a control logic code already being executed on a selected device.

In the case that new control functionality shall be added to the networked control system already in operation the logic design may be as described above. The compiler function then translates the new control logic to runtime code. For assigning the new logic to a device the distribution of the existing logic may be taken into account. Furthermore, instantiating the support logic may be an addition to the support logic already in the system.

According to an embodiment a process of designing control logic and initializing or setting up the networked control system may include the steps logic design, compilation, system setup and maintenance.

Logic design may be performed by a user or designer of the networked control system and includes a development of the control logic programs on the collection of all device logic in the networked control system. This “design view” is performed without specifying the device the related runtime control logic code will be executed on in the runtime system. In a preferred embodiment, the logic design is done using graphical tools.

Compilation of the control logic programs created in the logic design may be performed automated. Translation of the control logic programs into executable control logic code, e.g. bytecode, for the runtime system includes the assignment of the control logic codes to devices the control logic codes shall be executed on during operation. The compilation step further includes an instantiation of the support logic realizing the communication of information necessary for running the control logic codes.

System Setup includes besides typical steps of network and application configuration also the upload of the control logic codes to the assigned devices.

System maintenance allows new control logic to be easily added to the networked control system after startup by simply repeating the previous steps with a new logic and downloading the new logic accordingly without the need to change the control logic already in the system.

On runtime, the control applications which define the runtime behaviour of and relations between the devices are realized by executing the control logic code on the assigned devices that deploy the support logic for the communication of information between devices where needed.

A later addition of control functionality is easy by repeating the steps from logic design to executor upload and support logic instantiation without the need to change the control logic already in the system

According to an embodiment, the compilation process step contains a step of translation of control logic programs into executable control logic code, a step of assignment of executing selected devices to the control logic, a step of assignment of master devices to system state variables and a step of automatic instantiation of support logic.

The step of translation of control logic programs into executable control logic code, e.g. bytecode, for the runtime system may be done as known in the art dependent on the specifics of the programming language.

The step of assignment of executing devices to the control logic includes assigning each piece of the control logic code to a device of the target system the control logic shall be executed on, i.e. by the processing unit of the device. The assignment of the control logic codes may be done manually, e.g. in the way that the user assigns the control logic programs to a device on which the related the control logic code shall finally run. To aid this process, default rules may be specified, e.g. that the default executing device is the master device of the output state variable or output state variables of the control logic code.

In a preferred embodiment, the assignment of control logic is computer-controlled or done automatically by the compiler program. The assignment may be performed by analysing an involvement of the devices in the control logic program as well as under consideration of the capabilities and resources of the devices. For example, a control logic code resulting from a control logic “Lamp X is dimmed by switch Y” may be assigned to lamp X, if it turns out, that switch Y has no non-volatile memory. Memory is only one example of device capabilities or resources that can be taken into consideration by the logic assignment process. On runtime, the executable control logic code will be executed in the runtime environment of the assigned device.

The step of assignment of master devices to system state variables includes assigning any user-defined system state variable to a device of the target system. This device is then the master device of this state variable, analogous to the device state variable, which means that in the runtime system this device holds an instance of the state variable and the value of this instance will be treated as “master” value for the state variable. The assignment of a system state variable to a master device may be done manually by the user. In a preferred embodiment, this assignment is computer-controlled or done automatically by analysing the involvement of the devices in the control logic program under consideration of their capabilities or resources.

The step of automatic instantiation of support logic realizing the communication of information necessary for running the control logic code allows for the design of control logic independent of the executing device. According to the invention, each control logic code is executed at one, freely selectable, assigned device.

A state variable is called “involved” in a control logic code if it is read by the control logic code or if it is changed by the control logic code. A state variable read by the control logic is an input state variable which also covers state variables used in events, e.g. start or stop, related to the control logic code. A state variable changed by the control logic code is an output state variable. A state variable can be both input and output state variable of a control logic code. Each state variable belongs to one and only one master device.

Considering one control logic code, each involved state variable is either internal to the device, if the device is a master device for this state variable, or external, if another device is master device for this state variable. If a state variable is internal, a current value of the state variable can easily be provided to the runtime environment of the control logic code directly by the device's hardware or software. For all external state variables, support logic is instantiated, which ensures, that the control logic code is always executed with correct state variable values.

For example, after the control logic code resulting from control logic “lamp X is dimmed by switch Y” is assigned to the lamp X, the support logic must assure, that on runtime the dimming level set by switch Y is made available to lamp X.

FIG. 3 shows a networked control system according to an embodiment of the present invention. The networked control system comprises a plurality of devices 100a, 100b, 100c, means 332 for collecting, means 334 for generating and an apparatus 200. The devices 100a, 100b, 100c and means 332, 334, 200 of the networked control system are connected by a communication system.

The devices 100a, 100b, 100c may be of the type described in FIG. 1. Each device is specified by corresponding device logic. The device logics represent attributes of hardware or software states of the corresponding devices.

The means 332 for collecting is configured to collect the device logics of the plurality of devices 100a, 100b, 100c. Further, the means 332 is configured to specify a runtime behaviour of at least one device 100b of the plurality of devices 100a, 100b, 100c. The runtime behaviour of the at least one device 100b is specified by taking into account the device logic which corresponds to the at least one device 100b. The means 332 for collecting is configured to provide the specified runtime behaviour to the means 334 for generating. The means 334 for generating is configured to create at least one device independent control logic program which represents the runtime behaviour provided by the means 332 for collecting. The at least one device independent control logic program defines the runtime behaviour of the at least one device 100b. The means 334 for generating is configured to provide the at least one device independent control logic program to the apparatus 200.

The apparatus 200 may be the apparatus as described in FIG. 2. The apparatus 200 is configured to receive the at least one device independent control logic program and to translate the at least one device independent control logic program into at least one device specific control logic code. According to this embodiment, the apparatus 200 assigns the control logic code to the third device 100c. The third device 100c is configured to execute the control logic code which controls the runtime behaviour of the second device 100b.

The selection of the third device 100c as device for executing the control logic code and the selection of the second device 100b as the device whose runtime behaviour is controlled by the control logic code is only exemplary.

According to an embodiment, the means 332 for collecting comprises an interface which allows a user to specify the runtime behaviour of the at least one device 100b. The interface may further allow the user to define the selected device 100c. The interface may be a graphic interface.

The means 332 for collecting may be configured to specify the runtime behaviour of the at least one device 100b based on further device logics corresponding to further devices the runtime behaviour of the at least one devices depends on. For example, if the runtime behaviour of the second device 100b depends on a state of the first device 100a, the means 332 for collecting may take into account the device logics of the first and second device 100a, 100b for specifying the runtime behaviour of the second device 100b.

The means 332 for collecting may be configured to specify the runtime behaviour of all the devices 100a, 100b, 100c based on all device logics. For defining the runtime behaviours of all devices 100a, 100b, 100c, the means 334 for generating may be configured to provide a plurality of different device independent control logic programs.

Logic design is a first step of the instantiation of a networked control system according to the invention. Logic design includes the development of control logic on the collection of all device logic in the networked control system (“design view”).

The control logic may be directly specified on a representation of physical devices. Alternatively, the control logic may be not be specified on a representation of physical devices. The logic design process may cover several abstraction levels. An example for covering several abstraction levels is the definition that “in all rooms, all lamps in that room are dimmed by the switch in the same room”. The logic design process may include use of graphical tools.

According to a preferred embodiment, the design process according to this invention will always consider the control logic independent of the device it will be executed on in the runtime system. For example, the user is generally only interested in specifying control logic like “lamp X is dimmed by switch Y”. In the runtime system, this piece of logic can be executed on the lamp X, on the switch Y or on any other device in the system, depending on devices capabilities or resources, without changing the behaviour of devices X and Y, as visible to the user.

The design view on the networked control system is represented by the compilable logic, consisting of a number of compilable logic programs. According to a preferred embodiment, the compilable logic programs are represented by human-readable scripts. The compilable logic programs are the output of the logic design process. This output may be generated in different ways, e.g. directly specified on collection of device logic of all or some physical devices or in a translation process from abstract logic on virtual devices of standardized types via the assignment of these virtual devices to real physical devices in the target system.

The compilable logic programs are defined on a uniform representation of the device logic of all devices belonging to the target system, i.e. on all device state variables of devices belonging to the networked control system. Furthermore, the user may define system state variables representing global state information, independent of the devices, e.g. average or aggregate values or state variables representing a global system state, like “nobody at home”. The control logic will then basically consist of operations on the state variables formulated in some programming language. The syntax of the control logic programs may be as for state-of-the-art scripting languages.

Control logic program specifications may furthermore contain the definition of events. An event may be the way a certain control logic program is triggered or stopped.

In a preferred embodiment a control logic program is triggered by default on any change of any of the state variables that are involved in the control logic represented by this control logic program. The user or logic designer may further refine this by restricting or extending the set of state variables that trigger the control logic program if their value changes or by conditions for the state variable values that have to be met before the control logic programs is triggered. Absolute or relative time may be one of considered triggers.

By default a certain control logic program will stop after all instructions in this control logic program have been executed. But the user may also define state variables which trigger stopping a running control logic program if the state variable value changes. Optional refinements similar as for starting triggers may be defined.

Several extended embodiments of the disclosed invention are possible. For example, the user may specify conditions for the events in the design view. These conditions may be included into the support logic implementing the subscription mechanism. This inclusion may be in a way that change notifications are only sent and/or executors are only triggered if the related condition is fulfilled. The condition may relate for example to absolute or relative state variable value change and/or to a minimum or maximum frequency of change notifications.

The above describes a system that enables development and establishment of control applications independent of the distribution aspects, thereby reducing the complexity of the control logic (as the user sees it) and the logic design process, and enabling a free allocation of control logic to devices, which allows for computer-controlled/automated system optimization after application development. In the end, such systems will allow also non-technical users to define and setup control logic easily and in an optimal way.

According to the present invention, the process of designing control logic and setting up a networked control system may be done in the following steps:
Logic Design (by the user/designer): Development of control logic on the collection of all device logic in the target system (“design view”) without specifying the device the related runtime code will be executed on in the runtime system. In an embodiment, the logic design may be done using graphical tools.
Compilation (automated): Translation of the control logic programs into executable (control logic) code (called Executors) for the runtime system (e.g. bytecode), incl. assignment of the Executors to devices they shall be executed on during operation. Instantiation of support logic realizing the communication of information necessary for running the Executors.
System Setup: Besides the typical steps of network and application configuration this step may also include the upload of the Executors to the assigned devices.
System maintenance: New control logic can also be easily added to the target system after start-up by simply repeating the above steps with the new logic and downloading it accordingly without the need to change the control logic already in the system.

The flexibility of a system according to the present invention may be particularly achieved by a tailored restriction of means to define application logic, called Control Logic Programs (CLPs). CLPs are defined on a uniform representation of the device logic of all devices—the device state variables (SVs). In addition, the user may define “system state variables” representing global state information (independent of the devices). The control logic may then basically consist of operations on the state variables formulated in some programming language (with syntax e.g. as for state-of-the-art scripting languages).

Dedicated concepts for more complex applications, e.g. controlling and managing groups of devices, may be of further advantage, particularly in case of restricted means for logic programming together with typical requirements for control system like small footprint, low bandwidth implementations. In the following, a further embodiment of this invention is described, which enables an efficient realization of group functions in a networked control system. The target system is a networked control system as described above, which may contain applications controlling groups of devices. Groups are an essential concept for logic design and maintenance. In the design view, device groups allow to define operations on common state variables of a set of devices (e.g. “set dim level of all lamps to value X”) or operations on a set of values (e.g. “average daylight value measured by a group of sensors”).

Groups can be derived from abstract design (e.g. “all lamps in the living room”) which leads to a typed group, e.g. group of type lamp. A group may as well be manually defined in direct design by arbitrarily grouping physical devices, e.g. all devices in a room (“arbitrary group” having no type).

Design View

A definition of a group in the design view may contain the list of member devices belonging to the group and may have further elements analogous to a device definition:
Group ID: Unique identifier of the group.
Group State Variables (SVs): A group SV represents the set of device SVs of same type (name) of the grouped devices. In the design view, group SVs are referred to as Group-ID.SV-name.
   Example: The group SV “Group.DimLevel” refers to set of device SVs “DeviceX.DimLevel” of all devices belonging to the group.
   The semantics, i.e. the meaning of commands to a group SV may be specified, but will be straightforward. For example, changing Group.SVx shall lead to changing related device SVx at each member device. In addition to commands, group SVs will also allow design view operations like average(Group.SVx) which returns the average value of all related device SVx values of all member devices
   In a typed group the group SVs may be given by the device SVs of the related device type. Note that only those group SVs may be relevant that are used in CLPs.
   In an arbitrary group, the group SVs may be given by all device SVs of devices in the group. A command to a group SV of an arbitrary group then simply refers to the set of related device SVs (of the group SV type).
Group Location: Optionally, a group may have location information, which means that all devices of the group have the same location information.

Compilation

The compiler may assign an address to the group (analogous to a device address) and per group SV used in CLPs, the compiler generates up to 2 system SVs (dependant on what kind of group logic is used in the system):
G.SV-ID representing values given to the (related state variables of the devices of the) group G
This SV is used to give commands (i.e. change the corresponding device SVs) to all devices of a group. For this usage, the G.SV-ID is used in CLP statements G.SVk:=<value> which shall lead to setting all member SVs D.SV-ID to <value>. Note, that this SV is a kind of “nominal value” SV as it contains the last request to change the grouped device SVs, while their actual values may also change independently (e.g. by real world events).
G.SV-ID.tab representing the list of all related device SVs
This SV is used to realize functions like “average” that read/evaluate to the set of grouped device SVs.

Afterwards, the compiler assigns these system SVs to master devices as described above. In the next step, the compiler generates support executors (in addition to the Executors generated from the CLPs) as part of the support logic defined and described above.
Change group SV value: If there are CLPs containing statements G.SVk:=<value> which shall lead to setting all member SVs D.SV-ID to <value> this is realized in the following way:
Each device D of group G (with a related device SV of same type) gets a (compiler generated) Executor with G.SV-ID as trigger SV (just trigger, no copy needed) and logic: D.SV-ID:=G.SV-ID (i.e. if G.SV-ID is changed, then D.SV-ID is changed accordingly)
The master device of G.SV-ID gets related subscription information. In an embodiment, the group IA address G is used as (only) subscription destination. All member devices store the address and listen (also) to messages with the group address as destination. In this case, the network abstraction layer will send change notifications as broadcast or multicast message. Alternatively, the master of G.SV-ID has the list of member devices as subscribers.

An advantage of this method is that devices can be added to the group later without changing an existing Executor (see below). In an arbitrary group only devices with related compatible SV will get a support Executor.
An alternative (not preferred) handling of group SVs:
The master device of G.SV-ID gets a (compiler generated) Executor with G.SV-ID as trigger SV and logic statements D.SV-ID:=G.SV-ID for all member devices, i.e. with output state variables D.SV-ID.
For this, the master device of G.SV-ID gets related reference information. The choice between the options can be done by the compiler.
Read/evaluation Functions for group SV (as input): If a CLP contains operations on all member values (e.g. “average”), a system SV G.SV-ID.tab is defined and assigned to a master device.
G.SV-ID.tab is a dynamic table {(Di,Di.SV-ID), i=1 . . . n} with the values of all member device SVs (in fact a piece of a distributed SV repository).
Each device D of group G gets master reference information for G.SV-ID.tab and a (compiler generated) support Executor with D.SV-ID as trigger SV and the logic:
G.SV-ID.tab:={(D,D.SV-ID)} (table with one element [D,D.SV-ID]).
At the master of G.SV-ID.tab the new value is interpreted as follows: if D is already in table then: overwrite value; else: add to table
Then functions like average(G.SV-ID) can be translated into Executor code having G.SV-ID.tab as input.
Extension: G.SV-ID.tab could also just be a reference list to member devices that is used to get (pull) D.SV-ID values on demand.

Note again, that only those group SVs are established that are used in CLPs. If e.g. there is no CLP deploying functions like average of all member values, then no G.SV-ID.tab SV will be generated.

Setup and Maintenance

As said above, the disclosed realization of group logic has also advantages for maintenance procedures like adding or removing devices to/from groups.
Adding a device that is only controlled by group logic (e.g. a lamp to an already existing lamp group)

To add a device D to a group the group definition has to be known (e.g. from a system repository).
If there is a group SV G.SV-ID then a related external instance of this SV is installed on the new device as well as the support executor (D.SV-ID:=G.SV-ID) described above. Furthermore, the group address G is added to the list of addresses device D listens to.
If the master of G.SV-ID uses subscriber lists, the new device has to announce its presence as member.
If there is a group SV G.SV-ID.tab and related logic, the new device needs to establish the master reference (address of master device) and install the support Executor (G.SV-ID.tab:={(D,D.SV-ID)})

The big advantage is that all steps to integrate the new device may be done on the new device, i.e. there is no need to change anything on the already existing device.
Removing a device having only group logic

A device having just group logic can simply be removed without the need to change anything in rest of system (system still fully functional).

In a further embodiment, garbage collection mechanisms may be applied to remove obsolete entries in the table of G.SV-ID.tab.

Summarized the invention describes:

A networked control system in which
control logic programs, defining the runtime behaviour of and relations between the devices, are specified by the user in the “design view” on the collection of particular or all device logic of the system, without indicating on which of those devices the final executable codes are to be run, and thus independently of any communication-related aspects;
a compiler program automatically translates specified control logic programs to executable code, assigns the executable code to devices executing it on runtime in an optimized manner, for example by taking device capabilities or resources into account, and automatically instantiates support logic at the devices such that on runtime this support logic provides for all necessary communication of information between devices involved in the control logic
all devices are prepared to run executable control logic code uploaded from the compiler function and to host support logic that, for example after appropriate instantiation by the compiler program, provides for all communication of information necessary for the hosted control logic in a way transparent to the control logic.

A device of a networked control system that
implements a runtime environment to execute executable code derived from the control logic specified in the “design view”
implements support logic that, for example after appropriate instantiation by a compiler program, provides for all communication of information necessary for all hosted control logic in a way transparent to the control logic

A compiler program for a networked control system that
translates control logic programs specified in the “design view” providing the collection of all device logic of the system, to executable code,
assigns the executable code to devices executing it on runtime in an optimized manner, for example by taking device capabilities or resources into account, and
automatically configures support logic of the devices such that on runtime this support logic provides for all necessary communication of information between devices involved in the control logic

A networked control system as described above to which control logic can be added also after system startup by repeating the same steps from logic design to control logic code (executor) upload and support logic instantiation without the need to change the control logic already in the system.

A method for adding new functionality to a networked control system in operation, comprising:
generating at least one new device independent control logic program according to the invention;
translating the new control logic program into a control logic code being executable on a selected device of the plurality devices;
transmitting the control logic code to the selected device; and
adapting a support logic of the selected device and the support logic of all devices having state variables used as input in the control logic program according to the invention, which in this case is an incremental operation, i.e. means adding information to the existing support logic.

A networked control system in which group logic is defined on group state variables.

A networked control system in which a compiler program automatically translates group logic into state variables G.SV-ID and G.SV-ID.tab and support executors as described above.

A networked control system in which setting the group SV to a value leads to setting all related member device SVs to the same value by

changing the master instance of the group SV to the value;

sending a related change notification of all subscribers of the group SV;

all subscribers have executors changing the related device SV to the new value of the group SV.

A networked control system as described above, where the change notification uses the group address as destination and all group members listen also to messages to this address.

A networked control system in which adding a device that is only controlled by group logic can be done without performing any change on devices already belonging to the system.

A networked control system in which adding a device to the system is done by adding the group address to the list of addresses it has to listen to and establishing group SV instances and support Executors as described above.

At least some of the functionality of the invention may be performed by hard- or software. In case of an implementation in software, a single or multiple standard microprocessors or microcontrollers may be used to process a single or multiple algorithms implementing the invention.

It should be noted that the word “comprise” does not exclude other elements or steps, and that the word “a” or “an” does not exclude a plurality. Furthermore, any reference signs in the claims shall not be construed as limiting the scope of the invention.

1. Device (100; 100a, 100b, 100c) for a networked control system including a plurality of devices, comprising:
a receiver (102) for receiving a control logic code which allows controlling a runtime behaviour of at least one device of the plurality of devices;
a runtime environment (104) for executing the control logic code; and
a support logic (106) being adaptable to the control logic code, wherein the support logic provides a communication link for exchanging state variables necessary for executing the control logic code.

2. Device according to claim 1, wherein the support logic (106) comprises means for receiving an instantiation message for adapting the support logic to the control logic code.

3. Device according to claim 1, wherein the receiver (102) is configured to receive a further control logic code which allows controlling a runtime behaviour of at least one second device of the plurality of devices, wherein the runtime environment (104) is configured to execute the further control logic code and wherein the support logic (106) is adaptable to the further control logic code.

4. Apparatus (200) for initializing a networked control system with a plurality of devices (100a, 100b, 100c) according to claim 1, comprising:
means (222) for translating a device independent control logic program which defines a runtime behaviour of at least one device (100b) of the plurality of devices into a control logic code being executable on a selected device (100c) of the plurality devices;
means (224) for transmitting the control logic code to the selected device; and
means (226) for adapting a support logic of the selected device and the support logic of all devices having state variables used as input in the control logic program, wherein the support logic provides a communication link for exchanging state variables necessary for executing the control logic code.

5. A networked control system, comprising:
a plurality of devices (100a, 100b, 100c) according to one of claims 1 to 3, wherein each device is specified by a corresponding device logic;
means (332) for collecting the device logics of the plurality of devices and for specifying a runtime behaviour of at least one device (100b) of the plurality of devices based on a device logic corresponding to the at least one device;
means (334) for generating at least one device independent control logic program which defines the runtime behaviour of the at least one device; and
an apparatus (200) for initializing according to claim 4.

6. The networked control system according to claim 5, wherein the means (332) for collecting is configured to specify a runtime behaviour of all the plurality of devices (100a, 100b, 100c) based on all device logics and wherein the means (334) for generating is configured to provide a plurality of device independent control logic programs.

7. The networked control system according to claim 5, further comprising at least one application being adapted to controlling a group of devices by means of operations on common state variables of the group of devices or on a set of values of the group of devices.

8. Method for initializing a networked control system with a plurality of devices according claim 1, comprising:
translating a device independent control logic program which defines a runtime behaviour of at least one device of the plurality of devices into a control logic code being executable on a selected device of the plurality devices;
transmitting the control logic code to the selected device; and
adapting a support logic of the selected device and the support logic of all devices having state variables used as input in the control logic program, wherein the support logic provides a communication link for exchanging state variables necessary for executing the control logic code.

9. Method for establishing a networked control system, comprising:
providing a plurality of devices (100a, 100b, 100c) according to one of claims 1 to 3, wherein each device is specified by a device logic;
collecting the device logics of the plurality of devices and specifying a runtime behaviour of at least one device (100b) of the plurality of devices based on a device logic corresponding to the at least one device;
generating at least one device independent control logic program defining the runtime behaviour of the at least one device; and
initialize the networked control system according to claim 5.

10. Method for establishing a networked control system according to claim 9, further comprising:
generating at least one new device independent control logic program defining the runtime behaviour of the at least one device;
translating the at least one new device independent control logic program into a new control logic code being executable on a selected device of the plurality devices;
transmitting the new control logic code to the selected device; and
adapting a support logic of the selected device and the support logic of all devices having state variables used as input in the at least one new device independent control logic program, which in this case is an incremental operation.

11. Method for adding new functionality to a networked control system according to claim 5, comprising:
generating at least one new device independent control logic program defining the runtime behaviour of the at least one device;
translating the at least one new device independent control logic program into a new control logic code being executable on a selected device of the plurality devices;
transmitting the new control logic code to the selected device; and
adapting a support logic of the selected device and the support logic of all devices having state variables used as input in the at least one new device independent control logic program, which in this case is an incremental operation.

12-13. (canceled)
